(19) United States
(12) Patent Application Publication
(10) Pub. No.: US 2006/0125792 A1
(43) Pub. Date: Jun. 15, 2006

(54) INPUT DEVICE ADAPTED FOR A VARIETY OF SURFACES OF DIFFERENT REFLECTIVE NATURES

(76) Inventor: Mao-Hsiung Chien, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/907,120

(22) Filed: Mar. 21, 2005

(30) Foreign Application Priority Data
Dec. 9, 2004 (TW) 093138160

(51) Int. Cl. G09G 5/08

(52) U.S. Cl. 345/166

(57) ABSTRACT

An input device includes a housing with an opening, a light source for generating light, a lens, a sensor for detecting light and generating an image signal, and a processing circuitry for receiving the image signal from the sensor and then generating a motion signal of the input device to a host to which the input device is coupled. The light source, the lens, the sensor and the processing circuitry are disposed inside the housing. An emitting side of the lens has a plurality of surfaces with distinctively different normals for providing distinct refraction angles for the light beams emitted from the light source. Therefore the sensor can detect light beams even if the roughness of the reflective surface changes.

### BACKGROUND OF INVENTION

1. Field of the Invention

The present invention relates to an input device adapted for a variety of surfaces of different reflective natures, and more particularly, to an optical mouse having a lens, an emitting side of the lens having a plurality of surfaces with distinctive different normals for providing distinctively different refraction angles for the light from a light source.

2. Description of the Prior Art

Traditional corded, ball-based mechanical mice are simple both in design and operational principles. They have worked well since the invention of the computer mouse but suffered from two insurmountable shortcomings: those annoying cords always seem to get in the way, and the tracking ball and the motion-detecting axes, continually gummed up with dirt, require frequent cleaning and thus cause inconvenience for users. With the rapid development in the computer industry, the traditional mechanical mice are gradually being replaced by optical mice using optical sensors that offer significantly improved precision, better tracking, and smoother cursor movement.

Sensing technology is the main focus in the computer mouse revolution. It provides users a better cursor orientation and applications on all kinds of surfaces. Developed by Agilent Technologies and introduced to the world in late 1999, the traditional optical mouse actually uses a tiny camera to take about 1500 pictures every second. The traditional optical mouse has a small red light-emitting diode (LED) serving as a light source that bounces light off the surface onto a sensor. The sensor sends each image to a digital signal processor (DSP) for analysis. The DSP is able to detect patterns in the images and see how those patterns have moved since the previous image. Based on the change in patterns over a sequence of images, the DSP determines how far the mouse has moved and sends the corresponding coordinates to the computer. The computer moves the cursor on the screen based on the coordinates received from the mouse. The patterns of reflected light from smooth surfaces are indistinguishable to the DSP of the LED optical mouse. In other words, the surface cannot be too reflective, or the LED optical mouse cannot detect enough irregularities to register movement. Therefore the LED optical mouse encounters operational problems during applications on smooth surfaces such as lacquered tabletops, glazed ceramic tile, untextured plastic, metal surfaces, photo paper, marble surfaces, opaque glass, and more. Also, the LED is a divergent light source whose strength dissipates with increasing distance and the sensitivity of an LED optical mouse is also affected.

Another type of optical mouse is the laser optical mouse which utilizes a laser diode (LD) as the light source. Laser illumination reveals structures that an LED simply cannot express. The coherent nature of laser light creates patterns of high contrast when its light is reflected from a surface. The pattern appearing on the sensor reveals details on any surface, even glossy surfaces that would look totally uniform when exposed to the incoherent LED illumination. The precision image sensors then have no difficulties in tracking on these patterns and calculating position and movement. This is how a laser optical mouse enables tracking on virtually any surface. Regarding power consumption, the laser mouse is also advantageous over the LED optical mouse due to a thinner active layer and smaller active current. Regarding chip size, the sensor module for the laser optical mouse is of similar size to that of the LED optical mouse, so chip minimization is not a problem. It is a natural trend for the laser optical mouse to become the mainstream in the future consumer market.

To detect movement, all sensor-based mice, regardless of light source, use sensors to “read” the light beam as it is reflected back into the mouse from the tracking surface. In a laser optical mouse, an LD serving as the light source illuminates light through a hole in a mouse housing, the light then being bounced off the surface to a sensor. Each second, the sensor inside the laser optical mouse takes more than 6000 snapshot ‘fingerprints’, converts the information to digital format and uses the changes in ‘fingerprints’ to calculate the mouse's precise location, speed and direction of movement. With that knowledge, the driver software of the laser optical mouse then communicates with the computer's operating system, which moves the cursor image on the screen accordingly. In the above-mentioned sensing process of an optical mouse, normally two sets of lenses are used to control the incident angle of the light source illumination to the surface and the reflecting angle of the reflected light to the sensor. Please refer to FIG. 1 for a prior art optical mouse using two sets of lenses for controlling light angles. The optical mouse in FIG. 1 includes a light source 10, a sensor 20, a first lens 30 and a second lens 40. The light source 10 illuminates a plurality of light beams 12. The light beams 12 are then refracted by the first lens 30, resulting in a plurality of light beams 32. The light beams 32 are then reflected by a surface 100, resulting in a plurality of light beams 34. The second lens 40 receives the light beams 34 and sends the light beams 34 to the sensor 20. In the prior art optical mouse in FIG. 1, the lens 30 refracts the light beams 12 from the light source 10 to the light beams 32; the lens 40 receives the light beams 34 resulting from the light beams 32 reflected by the surface 100 and then sends the light beams 34 to the sensor 20.

In the prior art optical mouse in FIG. 1, the first lens 30 and the second lens 40 are disposed at a certain angle designed according to a certain operational environment. When being operated in different environments, the sensitivity of the sensor 20 can be influenced due to different reflection indexes of the operational surfaces. Please refer to FIG. 2. FIG. 2 is a diagram of the prior art optical mouse in FIG. 1 operating on a surface 200. If the surface 200 provides a plurality of distinct reflection angles for the incident light, after being reflected by the surface 200, the light beams 32 result in a plurality of light beams 36 that can have different angles and can be out of the receiving range of the lens 40. Thus the effectiveness of the sensor 20 is largely negated.

The two sets of lenses of the prior art optical mouse are designed for certain surfaces. When it is used in a different environment, for example on a surface with different degrees of roughness, the sensor can only detect part of the reflected light from the light source illumination and thus is unable to function effectively. Also, the two sets of lenses increase the manufacturing cost of the optical mouse.

### SUMMARY OF INVENTION

It is therefore an objective of the claimed invention to provide an optical mouse to solve the problems encountered in the prior art.

The present invention provides an input device adapted for a variety of surfaces of different reflective natures, the input device comprising a housing, a light source, a lens, a sensor and a processing circuitry. The housing has an opening. The light source is disposed within the housing for emitting light. The lens is disposed within the housing and cooperates with the light source in a way an emitting side of the lens having at least two surfaces with distinctively different normals, so as to provide distinctively different refraction angles for the light emitted from the light source. The sensor is disposed within the housing to sense the light reflected from the surface through the opening of the housing and generating an image signal. The processing circuitry is disposed within the housing to receive the image signal from the sensor and then to generate a motion signal of the input device to a host to which the input device is coupled.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a prior art optical mouse operating on a surface.

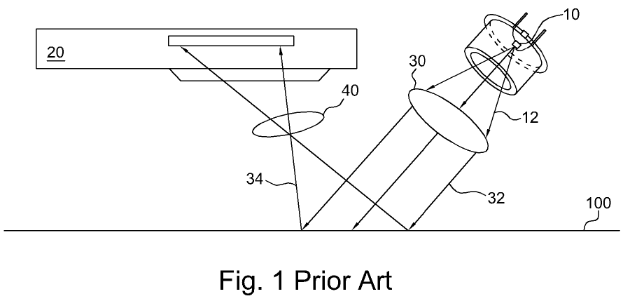

FIG. 2 is a diagram of the prior art optical mouse in FIG. 1 operating on another surface.

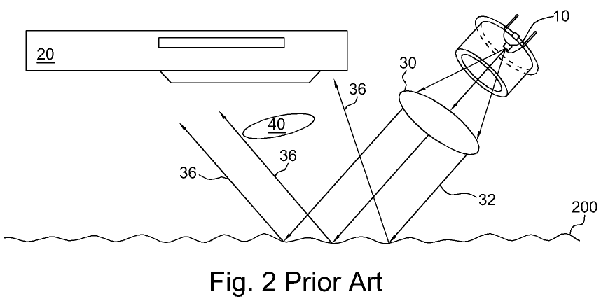

FIG. 3 is a diagram of an optical mouse according to the present invention.

FIG. 4 is a diagram of another optical mouse according the present invention.

### DETAILED DESCRIPTION

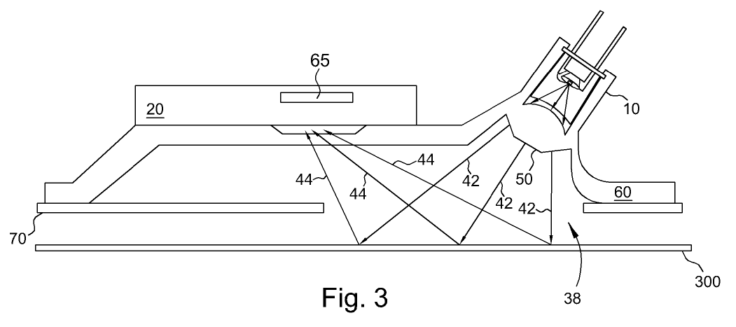

Please refer to FIG. 3 for a diagram of an input device according to the present invention. The input device in FIG. 3 is an optical mouse coupled to a host (a computer, for example) that includes a light source 10, a sensor 20, a lens 50, a frame 60, a processing circuitry 65 and a housing 70. The light source 10, the sensor 20, the lens 50, the frame 60 and the processing circuitry 65 are disposed within the housing 70 having a opening 38. The light source 10 can be a laser diode (LD), a light emitting diode (LED) or other optical devices. An emitting side of the lens 50 has at least two surfaces with distinctively different normals for providing distinctively different refraction angles for the light beams emitted from the light source 10, resulting in a plurality of light beams 42. The lens 50 can be connected to the light source 10 through the frame 60, or can be formed as an integral part of the frame 60. The sensor 20 senses a plurality of light beams 44 reflected from a surface 300 through the opening 38 of the housing 70 and generates an image signal. The processing circuitry 65 receives the image signal from the sensor and then generates a motion signal of the input device to the host.

Since the emitting side of the lens 50 has a plurality of surfaces with distinctively different normals, it refracts the light beams emitted from the light source 10 into the plurality of light beams 42 having a plurality of different incident angles. The light beams 42 then pass through the opening 38 and are reflected by the surface 300, resulting in the plurality of light beams 44 having a plurality of different angles. Therefore even if the operational environment has different reflection indexes, for example the surface 300 being a surface with different degrees of roughness, since the light beams 44 have a plurality of different angles, the chance that the sensor 20 can receive the light beams 44 is also increased. The lens 50 in the present invention improves the sensitivity of the sensor 20, especially when the optical mouse is operating on a surface that has different reflection indexes, as indicated in FIG. 3.

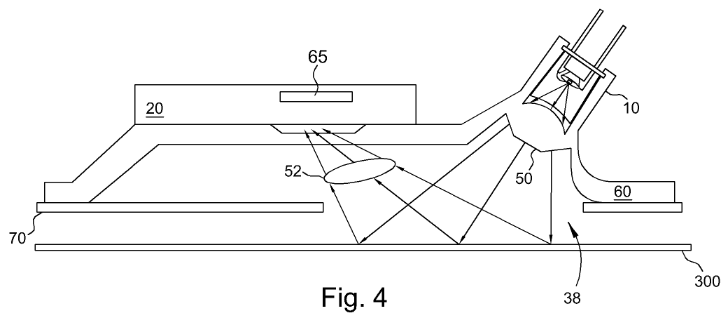

Please refer to FIG. 4 for a diagram of another input device according to the present invention. The input device in FIG. 4 is an optical mouse coupled to a host that includes a light source 10, a sensor 20, a lens 50, a lens 52, a frame 60, a processing circuitry 65 and a housing 70. The light source, the sensor 20 and the lens 50, the lens 52 and the processing circuitry 65 are disposed in the housing 70. The housing 70 includes a opening 38. FIG. 4 differs from FIG. 3 in that the optical mouse of FIG. 4 further includes a lens 52. The lens 52 can further improve the sensitivity of the sensor 20. But since the lens 50 having a plurality of surfaces with distinctively different normals already largely improves the sensing ability of the sensor 20, the lens 52 is not necessary in the present invention. However, an optical mouse that controls the light with the lens 50 and the lens 52, as illustrated in FIG. 4, is also included in the scope of the present invention.

Compared to the prior art, the present invention improves the sensitivity of the sensor and adapts to different operational environments through using a lens whose emitting side has a plurality of surfaces with distinctively different normals. The present invention also reduces the cost of manufacturing by eliminating the need for the two sets of lenses in the prior art optical mouse.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An input device adapted for a variety of surfaces of different reflective natures, said input device comprising:
a housing having an opening;
a light source disposed within the housing for emitting a plurality of light beams;
a lens disposed within the housing and cooperating with the light source in a way an emitting side of the lens having at least two surfaces with distinctively different normals, so as to provide distinctively different refraction angles for the plurality of light beams emitted from the light source;
a sensor disposed within the housing to sense the light beams reflected from the surface through the opening of the housing and generating an image signal; and
a processing circuitry disposed within the housing to receive the image signal from the sensor and then to generate a motion signal of the input device to a host to which the input device is coupled.

2. The input device of claim 1 further comprising a frame disposed on the light source.

3. The input device of claim 2 wherein the lens is formed as an integral part of the frame.

4. The input device of claim 2 wherein the frame is connected to the lens.

5. The input device of claim 1 wherein the light source comprises a laser diode.

6. The input device of claim 1 wherein the light source comprises a light emitting diode.

7. The input device of claim 1 including an optical mouse.
